(19) United States
(12) Patent Application Publication
(10) Pub. No.: US 2015/0252824 A1
(43) Pub. Date: Sep. 10, 2015

(54) HOLDER FOR CONNECTING A MODULE TO A COMPONENT OF AN AIRCRAFT OR SPACECRAFT, ARRANGEMENT, AIRCRAFT OR SPACECRAFT, AND METHOD

(71) Applicant: Airbus Operations GmbH, Hamburg (DE)

(72) Inventors: Hermann Benthien, Hamburg (DE); Matthias Hegenbart, Hamburg (DE); Sheriff Shehata, Bremen (DE)

(73) Assignee: Airbus Operations GmbH, Hamburg (DE)

(21) Appl. No.: 14/636,507

(22) Filed: Mar. 3, 2015

(30) Foreign Application Priority Data
Mar. 6, 2014 (DE) 10 2014 204 087.6

(51) Int. Cl. F16B 2/02; F16M 11/22; F16B 11/00

(52) U.S. Cl. CPC F16B 2/02; F16B 11/006; F16M 11/22

(57) ABSTRACT

A holder for connecting a module to a component of an aircraft or spacecraft includes a first holder portion having a first adhesive face and a second holder portion having a second adhesive face. The first and second holder portions are movable relative to one another in an initial state of the holder such that a portion of the component can be received between the holder portions so as to glue the holder portions to the component by means of an adhesive layer in each case. The holder has two or more guided parts which are movable relative to one another by means of mutually cooperating guide faces in the initial state of the holder. The guide faces are suitably formed for being glued together using an adhesive. The holder can be used to counter peeling stress of an adhesive connection of the holder in the region of the first and/or second adhesive face.

### FIELD OF THE INVENTION

The present invention relates to a holder for connecting a module to a component, for example a structural component, of an aircraft or spacecraft. The invention further relates to an arrangement in an aircraft or spacecraft comprising a structural component of the aircraft or spacecraft, a module, and a holder of this type. The invention further relates to an aircraft or spacecraft, in particular an aeroplane, comprising an arrangement of this type, and to a method for fixing a holder for connecting a module to a component of an aircraft or spacecraft.

Although embodiments of the invention may be of use in the context of connecting different modules to components of an aircraft or spacecraft, or else in the context of connecting modules to components in other technical fields, aspects of the present invention and the set of problems on which they are based are to be explained in greater detail in the following using the example of fixing an equipment module or a system line or the like to a primary structural component of an aeroplane.

### BACKGROUND OF THE INVENTION

So as to fix modules, such as equipment modules, technical modules, systems, lines such as electrical lines, for example power supply lines or signal lines, fibre optic lines, fluid-bearing lines for gases and/or liquids such as air, water, wastewater or hydraulic liquid, to a primary structure of an aeroplane, holding devices may be used, which in a conventional design are fixed to the primary structure using rivet connections.

However, rivet connections of this type involve an increased work outlay during production. Further, it may be necessary to take holes for connecting rivets into account when configuring a component of the primary structure, so as to prevent the component from being loaded and/or weakened in an unacceptable manner as a result of the hole and the load introduction by the holding device.

It is therefore desirable to hold equipment modules, systems, system lines and the like in an aeroplane without riveting of this type being required.

For example, DE 10 2010 026 877 A1, see also US 2012/0006236 A1, proposes an adhesive holder and a construction kit for manufacturing an adhesive holder, this adhesive holder comprising a counter element and an adapter. A counter face of the counter element can be positioned at a distance from a support face of the adapter so as to enclose a portion of a structural element. An adhesive layer is applied to the counter face and/or the support face so as to hold the adhesive holder of DE 10 2010 026 877 A1 in position along the structural element. By way of this adhesive holder, a positive connection to the structural element is to be made. However, the adhesive holder proposed in DE 10 2010 026 877 A1 is constructed from a relatively large number of individual modules.

It would therefore be desirable to have a holder for connecting a module to a component of an aircraft or spacecraft which is simpler, is constructed from fewer modules and can preferably also be mounted with less effort on the component.

### BRIEF SUMMARY OF THE INVENTION

Against this background, one idea of the present invention is to specify a holder for connecting a module to a component of an aircraft or spacecraft, which on the one hand is of simple construction and easy to handle, and which on the other hand can be glued reliably and durably to the component. A further idea of the invention is to provide a correspondingly improved arrangement in an aircraft or spacecraft, a correspondingly improved aircraft or spacecraft, in particular an aeroplane, and a correspondingly improved method for fixing a holder for connecting a module.

Accordingly, a holder for connecting a module to a component of an aircraft or spacecraft is provided which comprises a first holder portion and a second holder portion. The first holder portion comprises at least one first adhesive face, whilst the second holder portion comprises at least one second adhesive face. In addition, the first holder portion and the second holder portion are formed in such a way and are movable relative to one another in a defined manner in an initial state of the holder in such a way that a portion of the component can be received between the holder portions so as to glue the holder portions to the component by means of an adhesive layer in each case. At least one adhesive layer in each case is arranged between the at least one adhesive face of the holder portion and the component. It is further provided that the holder comprises two or more parts, the parts or predetermined mutually cooperating parts from the more than two parts being guided so as to be movable relative to one another by means of mutually cooperating guide faces in the initial state of the holder. The guide faces are provided and are suitably formed for being glued together using an adhesive. In the proposed holder, the adhesive faces, the parts and the guide faces are arranged in such a way that the adhesion of the guide faces can be used to counter a peeling stress of an adhesive connection of the holder to the component of the aircraft or spacecraft in the region of the first and/or second adhesive face when the holder is loaded by the connected module.

Further, an arrangement in an aircraft or spacecraft is provided which comprises a component, in particular a structural component, of the aircraft or spacecraft, a module, and a holder of this type according to the invention. In the arrangement, the holder portions of the holder are each glued to the component by means of an adhesive layer between the at least one adhesive face of the holder portion and the component. Further, the guide faces are glued together. The module is held on the component by means of the holder.

According to an embodiment of the invention, an aircraft or spacecraft, in particular an aeroplane, is provided, which comprises an arrangement of this type.

In addition, a method is proposed for fixing a holder for connecting a module to a component of an aircraft or spacecraft. The method comprises the steps of:
providing a holder, which comprises a first holder portion and a second holder portion for receiving a portion of the component between the holder portions. The first holder portion comprises at least one first adhesive face and the second holder portion comprises at least one second adhesive face;
applying an adhesive to the adhesive faces and/or to the portion of the component of the aircraft or spacecraft;
bringing about or unblocking a movement of the first holder portion and the second holder portion relative to one another, in such a way that in each case an adhesive layer is formed between the at least one adhesive face of the holder portion and the portion of the component received between the holder portions, so as to glue each of the holder portions to the component;
introducing an adhesive into an adhesive gap between mutually cooperating guide faces, by means of which two or more parts of the holder or predetermined mutually assigned parts from the more than two parts of the holder are guided so as to be movable relative to one another in an initial state of said holder. The adhesive is introduced so as to glue the guide faces together and so as to counter a peeling stress of an adhesive connection of the holder to the component of the aircraft or spacecraft, in the region of one or both adhesive faces, when the holder is loaded by the connected module, by gluing the guide faces.

In particular, it is proposed to fix a holder according to an embodiment of the invention to the component by means of the above method.

A concept of the present invention is that an adhesive holder for connecting a module to a component of an aircraft or spacecraft, for example in the production process of an aircraft or spacecraft, can be handled in a much simpler manner if parts of the holder are coupled together using guide faces, which make possible guided, defined movement of the parts relative to one another. If the holder is positioned in the desired position on the component, for example a structural component, such as a former, a stringer, a crossbar or the like, and if the adhesive faces of the two holder portions are pressed against the component with the adhesive layers interposed, the movement of the parts of the holders relative to one another can be blocked and the occurrence of peeling stress at one or both of the primary adhesive faces against the component prevented, in a simple and rapid manner, by introducing an adhesive into an adhesive gap between the guide faces. If the adhesive has achieved its desired target strength after a sufficient time period has passed, for example by hardening, the holder, which in the unfixed initial state comprises a number of movable parts, can in the finished mounted state form an intrinsically integrally glued holding device, positively glued to the component and protected against peeling stress of the adhesive connections, for the module, having a high loading capacity. It is not necessary to rivet the holder to the component.

In the arrangement according to an embodiment of the invention and the aircraft or spacecraft according to an embodiment of the invention, a variety of different modules, having a wide range of masses or weights, can be held on the component using the holder. These may for example be system lines, equipment modules and the like. However, the holder could also be used for connecting a structural module to the component, since it can be formed and fixed with a very high loading capacity and reliability. The arrangement according to an embodiment of the invention may advantageously be used, in particular, in applications such as aviation where large temperature fluctuations, potentially in combination with humidity, can act on the fixed holder over long periods.

Advantageous embodiments and developments of the invention may be taken from the description with reference to the drawings.

In one embodiment of the invention, the first holder portion and the second holder portion are set up to enclose the portion of the component from substantially opposite sides of the portion. In this way, effective positive adhesion of the holder to the component can be achieved.

In a further embodiment of the invention, the movability of the first and second holder portions relative to one another makes the holder continuously adaptable to one or more dimensions of the portion of the component. This is advantageous because as a result the holder can be used on components of different dimensions, in particular different thicknesses or wall thicknesses, making it possible to improve the flexibility of manufacture.

In a further embodiment of the invention, a first of the parts and a second of the parts are guided movably relative to one another by means of the guide faces which are provided for this purpose. In this embodiment, the at least one first adhesive face is arranged on the first of the parts, and the at least one second adhesive face is arranged on the second of the parts. As a result, the first holder portion forms a portion of the first of the parts, and the second holder portion forms a portion of the second of the parts. This constitutes an expedient possibility for implementing the movability of the holder portions relative to one another.

In a development, the first of the parts and the second of the parts are guided displaceably relative to one another. In particular, the first of the parts and the second of the parts may be guided displaceably linearly, in other words in a straight line, relative to one another. In this way, the adhesive faces are made accessible to a worker for the application of an adhesive to form the adhesive layers, and in addition the portion of the component is received between the holding portions in such a way that a reliable uniformly adhesive layer is formed.

In a development, the first of the parts may comprise a shaft, at least one of the guide faces, which is used for the displaceable guidance of the first of the parts relative to the second of the parts, being formed on the shaft.

In a development, the first of the parts and the second of the parts are guided pivotably relative to one another. This can contribute to achieving a compact configuration of the holder.

In a further development, the first of the parts and the second of the parts may be formed pivotably and displaceably relative to one another. As a result, the tolerance compensation during the gluing of the holder can be further improved and the field of use thereof further widened.

In a further development, the first of the parts and the second of the parts are guided displaceably and/or pivotably on one another by way of the cooperating guide faces which are provided for this purpose, of which one is provided on the first of the parts and one on the second of the parts. In this way, a particularly simple holder formed with few components can be achieved.

In a development, the second of the parts may be guided displaceably on the shaft of the first of the parts.

In a development, the holder comprises at least one interface device for directly or indirectly coupling the holder to the component. The interface device may be provided on the first of the parts or the second of the parts. In alternative developments, a plurality of interface devices may be provided, of which for example one may be provided on the first of the parts and one on the second of the parts. Interface devices of this type make it possible to connect the holder, which is mounted on the component and fixed by the adhesion, to the module or to coupling elements and the like for coupling the module. In particular interface devices formed in a unitary or standardised manner, for example in combination with coupling elements adapted to the module respectively to be fixed, can contribute to greatly improved production flexibility.

In a further development, the first of the parts and the second of the parts are guided movably relative to one another by interposing a third of the parts, which is guided movably relative to the first of the parts and relative to the second of the parts by means of the guide faces which are respectively provided for this purpose. This can make it possible to configure the movable guidance of the first and second parts relative to one another in a more variable manner and thus to make the holder more flexibly useable.

In a development, the first of the parts and the second of the parts may each be guided pivotably on the third of the parts by means of the guide faces which are provided for this purpose. In particular, the first of the parts and the second of the parts may be pivotable about the same axis with respect to the third of the parts. In this way, it is possible to adjust the third part even better with respect to the first of the parts and the second of the parts.

In a further development, the third of the parts is guided displaceably on the first of the parts by means of the guide faces which are provided for this purpose, whilst the second of the parts is guided displaceably on the third of the parts by means of the guide faces which are provided for this purpose. This may on the one hand contribute to the possibility of adjusting the distance between the first of the parts and the second of the parts and thus also the distance between the first holder portion and the second holder portion by way of the displaceability, making adaptation to the dimensioning of the portion of the component possible. On the other hand, by means of the pivotability, deviations of the portion of the component from the target shape thereof, for example non-parallelism of two opposite side faces of the component, can be compensated.

In a variant, in which the first of the parts comprises the shaft, the third of the parts may, in a development, be guided displaceably on the shaft.

In a variant, in which the third of the parts is interposed between the first of the parts and the second of the parts, the holder may, in a development, comprise at least one interface device for directly or indirectly coupling the holder to the component, the interface device being provided on the first of the parts or on the second of the parts or on the third of the parts. A plurality of interface devices could also be provided in this development, of which at least one may respectively be provided on the first, the second and/or the third of the parts.

In a further development, the holder may comprise a further part which is guided movably on the first of the parts or on the second of the parts by means of additional guide faces. The holder may comprise an interface device for directly or indirectly coupling the holder to the module, the interface device being provided on the further of the parts. It should be noted that the additional guide faces mentioned above need not necessarily be among the guide faces of which the adhesion contributes to countering the peeling stress of the adhesive connection to the component.

In an alternative embodiment of the invention, the first and second holder portions are in the form of portions of a first of the parts. The first of the parts comprises a resilient element or is in the form of a resilient element. In this embodiment, the holder is formed in such a way that the movability of the holder portions relative to one another in a defined manner can be brought about in the initial state of the holder by resilient deformation of the resilient element. A holder in accordance with this alternative embodiment has a particularly simple construction.

In a development, the resilient element may be in the form of a spring steel sheet, in particular a substantially U-shaped spring steel sheet.

In a further development of the alternative embodiment, a second of the parts and a third of the parts may be guided movably from different sides of the first of the parts by means of the guide faces which are provided for this purpose. In particular, the second of the parts and the third of the parts may additionally be guided movably on one another by means of the guide faces which are provided for this purpose. In this way, a peeling stress of the adhesion with respect to the portion of the component is countered, whilst a highly compact holder is simultaneously created.

In a further development of the alternative embodiment, the third of the parts may penetrate through the first of the parts or the second of the parts in portions. The holder can thus be formed even more compactly.

In particular, in the alternative embodiment of the holder, the first and second holder portions may form limbs, arranged mutually opposed, of the first part.

An interface device for directly or indirectly coupling the holder to the module may be provided on the second or third of the parts, which are movably guided thereon from different sides of the first of the parts.

In one configuration of the invention, an adhesive shoe in each case is arranged on the first holder portion and/or on the second holder portion, and is set up to adapt the holder to different geometrical shapes or dimensions of the portion of the component. An adhesive shoe of this type may for example also be used so as to take into account particular geometrical data in the region of the portion of the component, such as steps, projections etc. Any production inaccuracies in the manufacture of the component, non-paralellisms of opposing faces of the portion of the component and the like could be compensated using adhesive shoes of this type. In particular if the first of the parts and the second of the parts have no linear displaceability with respect to one another, adhesive shoes of this type may be useful for adapting the holder to components of different thicknesses or wall thicknesses. In particular, in the case of this embodiment, the at least one first adhesive face and the at least one second adhesive face are each arranged on one of the adhesive shoes.

In a further embodiment, the holder comprises a force application device, which is set up to press the first and second holder portions against the portion of the component of the aircraft or spacecraft. This further simplifies the handling of the holder. In particular, after the adhesive is applied to the component to form the adhesive layers, the holder may already hold on its own before the adhesive hardens, without being held by the worker. Whilst in some cases the use of further devices such as tongs and the like for pressing the holder portions against the component is omitted, and the complexity of manufacture can thus be reduced, in other cases this configuration can simplify at least the application of tongs of this type or a similar manufacture means for the worker. However, it should be noted that in this context the holder should be fixed by positive adhesion. In this case, the force application device therefore preferably only serves to press the holder portions against the component temporarily and in particular during an assembly and hardening process—in the solidified state of the holder, in which the adhesives have achieved their target strengths, the force application device is subsequently no longer needed. For reasons of simplified handling, it may be desirable to leave a force application device of this type in or on the fully solidified holder.

In an embodiment in which the first of the parts is in the form of a resilient element or comprises a resilient element, the resilient element may, in a development, advantageously serve as the force application device.

In other embodiments, the force application device may be formed with a spring element, in particular with a helical spring and/or a torsion spring. A plurality of spring elements may be provided to form the force application device. For example, a helical spring and a torsion spring may be provided, which operate in series. A force application device formed with at least one spring element may advantageously make it possible to press the first holder portion and the second holder portion against the component automatically using spring force, so as to hold the adhesive faces in contact with the portion of the component indirectly via the adhesive layers when the worker releases the holder portions in the desired position on the component.

In a further embodiment, the force application device may be set up to bring about the application of a force for pressing the holder portions against the component by means of a screw movement. In this embodiment, additional gripping means, which are removed again when the adhesive used has achieved its target strength, can advantageously be omitted. In addition, in this embodiment the worker can, if desired, vary the contact force which is brought about by means of the screw movement.

In another embodiment of the invention, however, a force application device remaining on or in the holder can be omitted. In this case, when the holder is fixed, the first and second holder portions and thus the adhesive faces can be pressed against the portion of the component, and subsequently pressed against the component by means of a suitable separate gripping or clamping device, such as tongs. The gripping is preferably maintained until the adhesive used has achieved a desired target strength. Subsequently, the device, for example the tongs or the like, can be removed again. In this embodiment, there is no additional weight from the force application device.

In a further embodiment, the holder may be formed in the manner of a collet, the first holder portion forming a first jaw and the second holder portion forming a second jaw of the holder.

In a further embodiment of the invention, an assembly aid, which is provided to simplify the gluing of the holder to the component in a predefined position, may be provided on the first holder portion or on the second holder portion. For example, the assembly aid may be in the form of a projection on the first holder portion or on the second holder portion. The projection may for example be arranged on the first or the second adhesive face. The assembly aid may be formed to cooperate with an assigned shape feature of the component, for example a depression formed for this purpose, so as to ensure that the holder is arranged in the correct position on the component. An assembly aid of this type simplifies the handling of the holder even further.

In a further embodiment of the invention, one or more of the guide faces comprise devices which make possible or simplify the injection of adhesive between the guide faces provided for gluing together. In particular, the one or more of the guide faces may be provided with injection grooves for the adhesive. This makes reliable gluing of the guide faces possible at the same time as advantageous handling.

In a further embodiment, one or more of the guide faces provided for gluing together are provided with depressions, for example with depressions distributed over the guide face. Using depressions or indentations of this type, as a result of the accumulation of adhesive therein, the spread of cracks in the adhesive layer which connects the guide faces in the solidified state of the holder can be prevented. The depressions in the guide face thus form what are known as crack stoppers.

In a further embodiment of the invention, an adhesive which is substantially free of hard particles of predetermined geometrical dimensions, in particular an adhesive which can be injected between the guide faces, is used for gluing the guide faces.

In one embodiment of the invention, the adhesive layers by means of which the first holder portion and the second holder portion are glued to the component are formed using an adhesive which contains hard particles of a predetermined dimensioning, compressive forces being transmissible from the holder portions to the component in particular via the hard particles. In this way, a highly load-bearing positive adhesion having a precisely defined adhesive gap can be achieved in the region of the first and second adhesive faces. In particular, as a result of the transmission of compressive forces via the hard particles, for example glass beads, a positive fit between the holder and component is achieved by way of contact of the particles with the holder portions and the component. In a development, the particles may be in the form of glass microspheres, having a diameter of for example 0.13 mm.

However, in an alternative embodiment, a defined adhesive gap in the region of the first and second adhesive faces with respect to the component could also be achieved in that a spacer, which is arranged between the holder portions or the respective holder portion and the component in a suitable manner, and by means of which the adhesive gap is adjusted, is used instead of an adhesive provided with hard particles. However, the use of an adhesive, into which the hard particles are mixed, is particularly simple and reliable, and can make it possible to transmit force indirectly via the hard particles.

In a further embodiment, the first holder portion and/or the second holder portion each comprise at least two adhesive faces. Preferably, at least two first and at least two second adhesive faces are provided, the first adhesive faces and the second adhesive faces in particular being positioned in the same plane. For example, this can be achieved in that a respective whole adhesive face is divided into two smaller partial adhesive faces by a groove which extends through it or by a slit. This measure increases the reliability of gluing the holder to the component in the region of the adhesive faces even further, since the propagation of any cracks through the adhesive face as a whole is prevented by the subdivision into a plurality of individual adhesive faces.

In further embodiments, the parts of the holder are formed using a plastics material. In this way, a lightweight and also robust holder can be achieved. However, in the event of corresponding requirements on the loading capacity, in a variant the parts of the holder may be formed using a metal material. In particular in an embodiment in which a first of the parts is in the form of a resilient element, the first part is preferably formed from a metal material, for example a spring steel.

In one embodiment of the invention, the module which is connected to the component of the aircraft or spacecraft by means of the holder may be in the form of a line, for example a signal line or a supply line. For example, the line may be a fibre optic line, an electrical line such as a power supply line, or a fluid-bearing line, for example for a gas or a liquid such as air, water, wastewater or hydraulic liquid. Alternatively, any other desired equipment components, parts of the internal equipment of the aircraft or spacecraft, system components etc. can be connected to the component as modules by means of the holder.

In one embodiment, the component is a structural component of an aircraft or spacecraft, in particular of an aeroplane. For example, the component may be a component of the primary structure of the aircraft or spacecraft, in particular a reinforcing component. The component may in particular be in the form of a former or a stringer or a crossbar. In this context, the holder may be formed in such a way that a flange or a web of the component can be enclosed in portions by means of the first and second holder portions.

In addition, it should be noted that in different embodiments of the invention the interface device, which is used for directly or indirectly coupling the holder to the component, may be formed in a very wide range of ways. For example, the interface device may be a thread, for example an internal or external thread. Alternatively, the interface device may be formed with recesses and/or projections and/or latch elements to form a plug-in connection. The interface device may be set up to couple the component or a portion thereof directly to the holder, and for this purpose for example directly receive a portion of the component, for example a portion of a line, a cable or a pipe. Alternatively or in addition, the interface device may be set up to be connected to an additional coupling element, such as a P clip, it subsequently being possible to couple the coupling element directly to the component. In different embodiments, the interface device may for example be connected to the coupling element by means of a plug-in, screw, latch or adhesive connection or a combination thereof.

The above embodiments and developments may be combined as desired, within reason. Further possible embodiments, developments and implementations of the invention also include combinations which are not explicitly disclosed of features of the invention which are disclosed above or in the following in relation to the embodiments. In particular, the person skilled in the art will also add individual aspects to the respective basic form of the present invention as supplements or improvements.

### BRIEF DESCRIPTION OF THE DRAWINGS

In the following, the present invention is described in greater detail by way of the embodiments specified in the schematic drawings, in which:

FIG. 1 is a schematic drawing of a holder in accordance with a first embodiment of the invention, arranged on a component of an aircraft or spacecraft, together with a component and a coupling element therefor;

FIG. 1A is a schematic partial drawing of a holder in accordance with a variant of the first embodiment;

FIG. 2 is a schematic drawing of a holder in accordance with a second embodiment, arranged on a component of an aircraft or spacecraft;

FIG. 3 is a schematic drawing of a holder in accordance with a third embodiment, arranged on a component of an aircraft or spacecraft;

FIG. 4 is a schematic drawing of a holder in accordance with a fourth embodiment, arranged on a component of an aircraft or spacecraft;

FIG. 4A is a schematic section E-E of the holder of FIG. 4;

FIG. 5 is a schematic front view of a holder in accordance with a fifth embodiment of the invention, arranged on a component of an aircraft or spacecraft;

FIG. 6 is a schematic section A-A of the holder of FIG. 5;

FIG. 7 is a schematic front view of a holder in accordance with a sixth embodiment, arranged on a component of an aircraft or spacecraft;

FIG. 8 is a schematic section B-B of the holder of FIG. 7;

FIG. 9 is a schematic drawing of a holder in accordance with a seventh embodiment of the invention, arranged on a component of an aircraft or spacecraft;

FIG. 10 is a schematic sectional drawing of a holder in accordance with an eighth embodiment, arranged on a component of an aircraft or spacecraft;

FIG. 11 is a schematic sectional drawing of a holder in accordance with a ninth embodiment, arranged on a component of an aircraft or spacecraft;

FIG. 11A is a schematic partial view of a variant of the holder of FIG. 11;

FIG. 12 is a schematic sectional drawing of a holder in accordance with a tenth embodiment of the invention, arranged on a component of an aircraft or spacecraft;

FIG. 13 shows a plug-in element for the holder in accordance with the embodiment of FIG. 12;

FIG. 14 shows two different, interconnectable extension elements as coupling elements for the holder in accordance with the tenth embodiment;

FIG. 15 is a perspective view of a holder in accordance with an eleventh embodiment of the invention;

FIG. 16 is a perspective, partially sectional view of the holder of FIG. 15;

FIG. 17 is a perspective view, sectioned in a central plane, of a holder in accordance with a variant of the eleventh embodiment;

FIG. 18 is a central section of the holder of FIG. 17;

FIG. 19 is a further sectional drawing of the holder of FIG. 17, sectioned in a plane C-C parallel to that of FIG. 18; see FIG. 17;

FIG. 20 is a schematic drawing of an adhesive layer, which is formed with an adhesive which contains hard particles of predetermined geometric shape and dimensions; and

FIG. 21 is a schematic sketch of an aircraft or spacecraft, in the form of an aeroplane, comprising a structural component and a holder fixed thereto.

### DETAILED DESCRIPTION

The accompanying drawings are intended to provide further understanding of the embodiments of the invention. They illustrate embodiments, and serve, in conjunction with the description, to describe principles and concepts of the invention. Other embodiments and many of the aforementioned advantages can be seen from the drawings. The elements of the drawings are not necessarily shown to scale with one another.

In the drawings, like, functionally equivalent and effectively equivalent elements, features and components are provided with like reference signs in each case, unless stated otherwise.

FIG. 1 shows a holder 1 in accordance with a first embodiment, which is arranged on a component 2 of an aircraft or spacecraft (not shown in its entirety) in the form of an aeroplane and is glued to a portion 3 of the component 2. The holder 1 serves to connect a module 103, shown as a line in FIG. 1 by way of example, to the component 2. The component 2 may for example be a former, a stringer or a crossbar of a fuselage cell structure of the aeroplane or another structural component of the aeroplane.

The holder 1 comprises a first holder portion 4 and a second holder portion 5. A first adhesive face 6 is provided on the first holder portion 4, whilst a second adhesive face 7 is provided on the second holder portion 5.

It can be seen from FIG. 1 that the holder 1 in accordance with the first embodiment is formed in the manner of a collet, the first holder portion 4 forming a first jaw and the second holder portion 5 forming a second jaw of the collet.

In the first embodiment, the first adhesive face 6 of the first holder portion 4 forms a portion of a first part 8 of the holder 1, whilst the second adhesive face 7 of the second holder portion 5 forms a portion of a second part 9 of the holder 1. The first part 8 comprises a shaft 10, which extends away from the first holder portion 4 to the second part 9 substantially at right angles to the first adhesive face 6. In the holder 1 of FIG. 1, the second part 9 is guided linearly displaceably on the shaft 10 of the first part 8 in the arrow direction 11, making it possible to slide the first holder portion 4 and the second holder portion 5 together in the arrow direction 11a when the holder 1 is fixed to the component 2, so as to encompass the component 2 from the substantially opposed faces 12, 13 thereof.

Thus, in the holder 1 of FIG. 1, the first holder portion 4 and the second holder portion 5 are movable relative to one another in the arrow direction 11 in a non-fixed initial state of the holder 1. This movability is achieved in that the parts 8 and 9 are guided displaceably on one another by means of a guide face 14 on the shaft 10 and a guide face 15, which is provided on the second part 9 and cooperates with the guide face 14.

As is further shown in FIG. 1, the holder 1 comprises an interface device 16, which is arranged on the shaft 10 and serves to connect the holder 1 to the module 103, in FIG. 1 a line by way of example, indirectly using a coupling element, in FIG. 1 a P clip 102 by way of example. In the first embodiment, the interface device 16 is formed by way of example as an internal thread, into which a screw can be screwed so as to connect the P clip 102 for the line to the holder 1.

FIG. 1A shows by way of example an end of a shaft 10 of a holder in a variant of the first embodiment, which otherwise corresponds to the holder 1 of FIG. 1. In FIG. 1A, an interface device 16′ for directly coupling the holder to a line 103 is provided on the shaft 10. In the example of FIG. 1A, the interface device 16′ comprises arms 16a′ and 16b′ for encompassing the line 103 and holding it in place.

So as to fix the holder 1 on the component 2 of the aircraft or spacecraft, the holder 1 is initially provided in an initial state in which the parts 8 and 9 can be moved in the arrow direction 11 with respect to one another. Subsequently, an adhesive, which is mixed with hard glass microspheres of a predetermined diameter so as to achieve a defined adhesive layer thickness, is applied to each of the two adhesive faces 6 and 7. Alternatively, the adhesive could also be applied to the portion 3 of the component 2.

Subsequently, the first holder portion 4 and the second holder portion 5 are moved towards one another in the arrow direction 11 relative to one another, in the manner of a collet, so as to clamp the component 2 between the holder portions 4 and 5 in the region of the portion 3. As a result, the portion 3 is encompassed and received between the holder portions 4 and 5, and the holder portions 4 and 5 are glued to the component 2 by way of an adhesive layer 18 between the first adhesive face 6 and the portion 3 and by an adhesive layer 17 between the second adhesive face 7 and the portion 3. For this purpose, the parts 8 and 9 are pressed against the component 2, resulting in a defined adhesive layer thickness being set as a result of the glass microspheres mixed into the adhesive, and making it possible to achieve a positive fit with the component 2. The adhesive layers 17 and 18 are shown schematically in dashed lines in FIG. 1. In the first embodiment, the parts 8 and 9 are pressed against the component 2 by means of an additional, separate device, for example tongs. The device is not shown in FIG. 1 for reasons of clarity. A contact force P is indicated by arrows in FIG. 1.

An adhesive free of hard glass microspheres is injected into an adhesive gap 19 between the first part 8 and the second part 9, and thus between the guide face 14 and the guide face 15 which is assigned thereto and cooperates therewith. The guide face 15 may for example enclose the shaft 10 and thus the guide face 14 in the peripheral direction, in that the shaft 10 penetrates through the second part 9. On the second part 9 for example, suitable injection grooves or the like (not illustrated in FIG. 1 however), for example standardised injection grooves, may be provided in the region of the guide face 15, so as to simplify and improve the injection of the adhesive between the guide faces 14 and 15.

As a result of the hardening of the adhesive layers 17 and 18 and the hardening of the adhesive in the adhesive gap 19, on the one hand the first and second parts 8, 9 of the holder 1 are glued to the component 2, and on the other hand the parts 8 and 9 are glued together in the adhesive gap 19. When the adhesive has achieved a target strength in all of the adhesive connections, the tongs (not shown here) can be removed. Subsequently, the module 103 can be coupled to the holder 1 by means of the interface device 16.

It can be seen from FIG. 1 that the holder 1 is glued to the component 2 from two sides. After gluing, the parts 8 and 9 form an intrinsically integrally glued piece. The construction of the holder 1 prevents peeling stresses in particular in the region of one or both adhesive layers 17 and 18. The gluing of the parts 8 and 9 in the region of the adhesive gap 19, in other words the gluing of the guide faces 14 and 15 in this region, prevents the adhesive connection of the holder 1 from being subjected to a peeling stress, for example in the region of the adhesive layer 18, when the holder 1 is loaded for example with a force F by the module which is connected to the component 2 by means of the holder 1. In FIG. 1, the introduced force F can be introduced into the second part 9 by shear force and into the component 2 via the glass microspheres of the adhesive layer 17 by compression, without the adhesive layer 18 being subjected to peeling. The holder 1 of FIG. 1 thus has a high loading capacity.

The holder of FIG. 1 is simple in construction and easy for the worker to handle. In addition, because of the continuously adjustable degree of opening between the two adhesive faces 6 and 7, the holder 1 in accordance with the first embodiment can be adapted to varying geometric dimensions of the portion 3 of the component 2, for example a varying thickness 20 thereof. As a result, the holder 1 of FIG. 1 can be used particularly flexibly on components 2 of different thicknesses or wall thicknesses.

As a result of the use of the adhesive filled with the hard glass microspheres to glue the adhesive faces 6 and 7 to the component 2, a defined adhesive gap can be set there, and this is highly advantageous for the reliability of the adhesive connection in this region. Further, compressive forces can be transmitted well via the glass microspheres by positive fit.

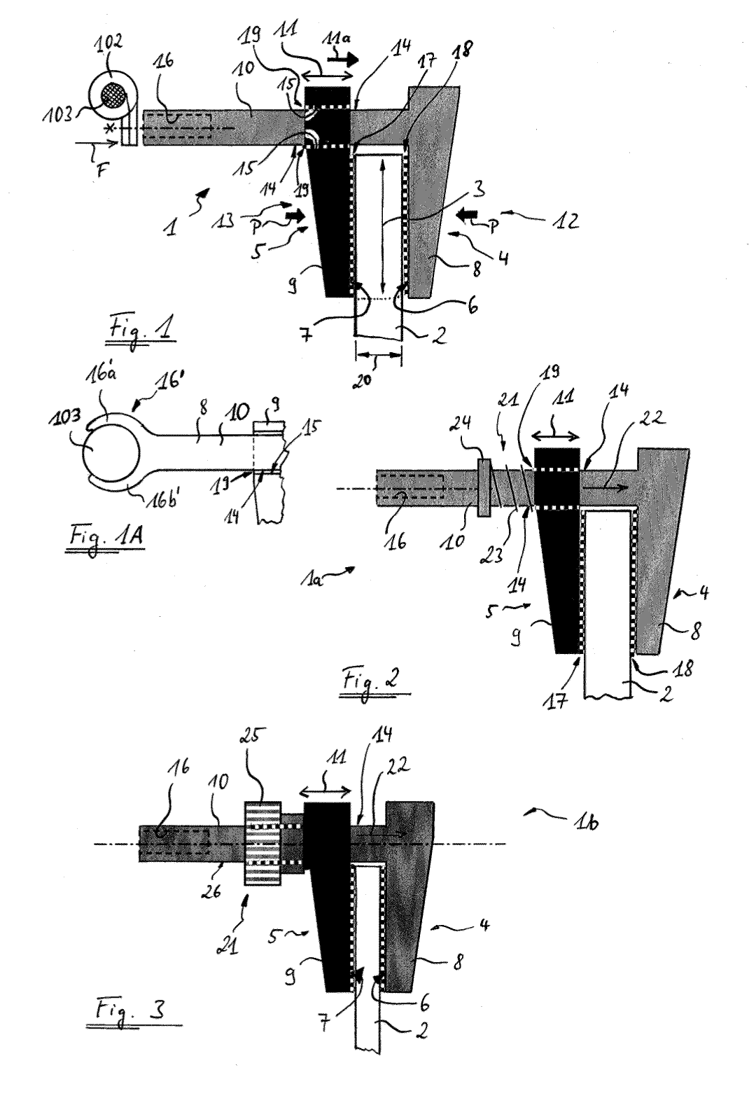

FIG. 2 shows a holder 1a in accordance with a second embodiment of the invention, which constitutes a variant of the first embodiment. The holder 1a in accordance with the second embodiment comprises all of the features of the holder 1 in accordance with the first embodiment, but is additionally equipped with a force application device 21. The force application device 21 applies a force to the second part 9 of the holder 1a, which force presses the second part 9 against the first part 9 and thus, as shown in FIG. 2, the two holder portions 4 and 5 against the component 2. Under the action of the force application device 21, the second part 9 thus moves towards the first part 8 in the arrow direction 22, unless it is pulled away from the first part 8, to the left in FIG. 2 for example, by a worker during the assembly of the holder 1a. In the second embodiment, the force application device 21 is in the form of a helical spring 23, which acts between the second part 9 and a recess 24 on the shaft 10 of the first part 8. It can be seen that in FIG. 2 the helical screw 23 is in the form of a compression spring. In addition to the advantages already mentioned in relation to FIG. 1, the holder 1a in accordance with the second embodiment of FIG. 2 has the further advantage that the complexity of assembly for fixing the holder 1a to the component 2 is further reduced in that the holder 1a is formed to be self-fixing. In the second embodiment, a biasing force, which is desired in the region of the adhesive layers 17, 18 and in the region of the adhesive gap 19 until the adhesive hardens and by means of which the first and second adhesive faces 6 and 7 are pressed against the component 2, can be produced by the force application device 21. The use of tongs is therefore either not required or, in cases where forces larger than can be applied by the force application device 21 are to be applied for gripping, is at least facilitated.

The worker can for example clamp the holder 1a, which is provided with adhesive in the region of the adhesive faces 6 and 7, against the component 2, on which the holder 1a subsequently automatically holds because of the action of the force application device 21, by letting go. The worker thus has both hands free for applying for example the tongs and for introducing adhesive into the gap 19. When the adhesives have achieved their target strength, in other words have hardened, the force application device 21 at the holder 1a is no longer necessary, but does remain in the holder 1a. Since the holder 1a is positively glued to the component 2, it cannot release as a result of the parts 8 and 9, for example made of plastics material, creeping over time.

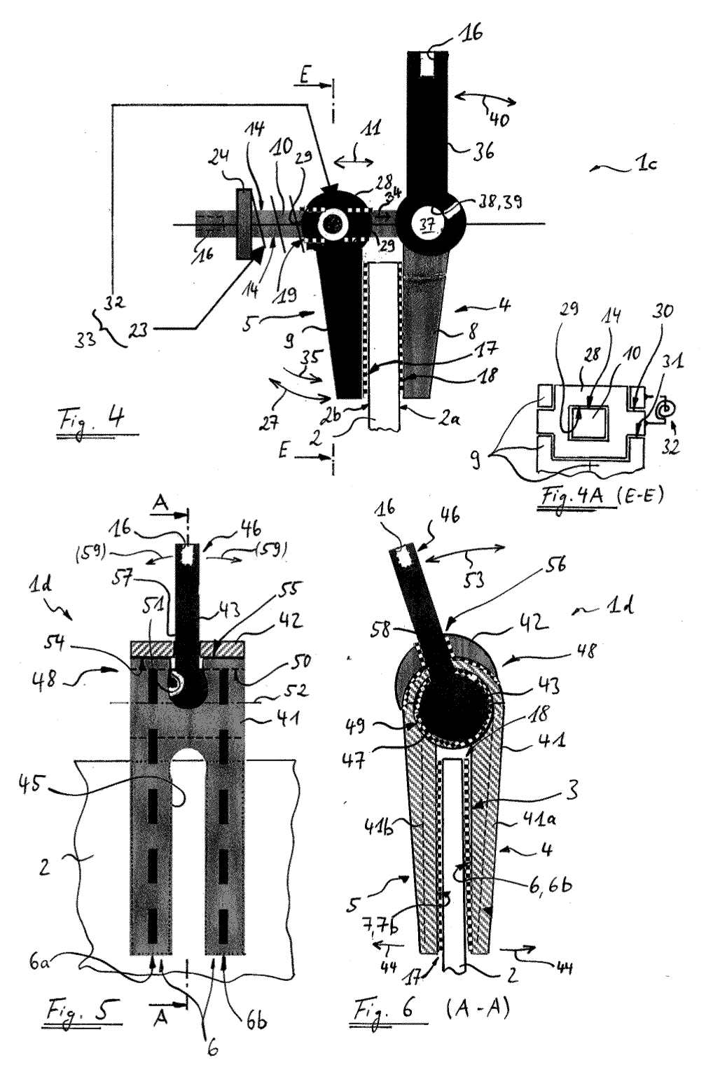

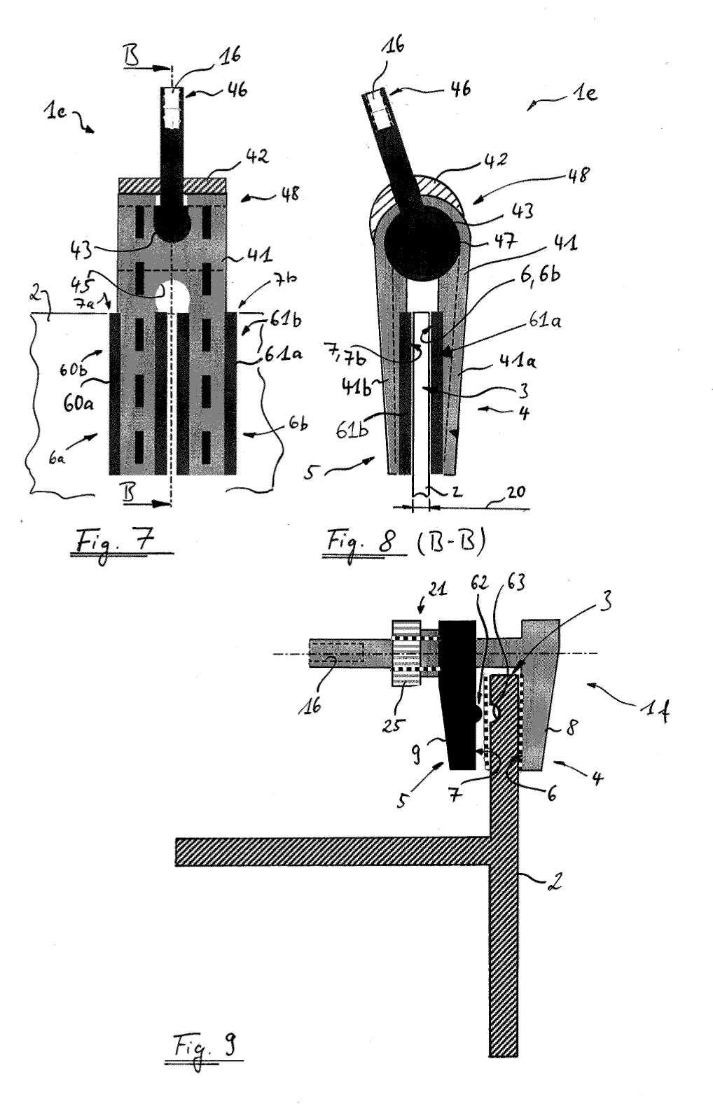

The holder 1b in accordance with the third embodiment of FIG. 3 constitutes a further variant. The third embodiment again comprises all of the features of the first embodiment, but in the third embodiment a force application device 21 is provided, but is now formed with a screw nut 25 (only shown highly schematically in FIG. 3) and with a thread 26 provided on the shaft (only indicated in FIG. 3). The holder 1b in accordance with the third embodiment thus also makes it possible to grip the second part 9 and the first part 8 together and thus to grip the holder portions 4, 5 against the component 2 in that the second part 9 is pressed against the first part 8 in the arrow direction 22. However, in the third embodiment this does not happen automatically under the effect of a tensioned spring element, as in the second embodiment, but rather as a result of the worker turning the screw nut 25. In the third embodiment too, as in the first embodiment, the second part 9 is guided displaceably on the shaft 10 of the first part 8 in the arrow direction 11, by way of the cooperation of guide faces 14 and 15, of which only the guide face 14 is visible in FIG. 3. In the third embodiment, the holder 1b is glued to the component 2 by applying the adhesive, provided with the hard glass microspheres, to the two adhesive faces 6 and 7, and by gripping the parts 8 and 9 against the component 2. In the region of the guide faces 14, 15, just as in the embodiment of FIG. 1, an adhesive free of glass microspheres is injected between them, for example by means of suitable injection grooves, so as to glue the guide faces 14 and 15 together. In a preferred variant, the screw connection, merely required during the fastening process, of the nuts 25 is also glued to the thread 26 in the thread engagement.

A holder 1c in accordance with a fourth embodiment of the invention is shown schematically in FIG. 4. In the holder 1c, not only are a first part 8 and a second part 9 of the holder 1c guided displaceably relative to one another in the arrow direction 11, but the parts 8, 9 are also guided pivotably relative to one another, making it possible to pivot the second part 9 in the arrow direction 27. This makes improved tolerance compensation possible in the event of non-parallelism of the side faces 2a, 2b of the component 2 due to manufacture, and additionally makes it possible to use the holder 1c in accordance with the fourth embodiment both on components comprising substantially parallel sides faces 2a, 2b and on components comprising side faces 2a, 2b which extend non-parallel by intention. This makes the possible field of use of the holder 1c even wider.

To achieve pivotability in the arrow direction 27, the holder 1c in accordance with the fourth embodiment is provided with a third part 28 (merely indicated schematically in FIG. 4), which is interposed between the first part 8 and the second part 9. The third part 28 is displaceable relative to the first part 8 in the direction 11, whilst the second part 9 is pivotable with respect to the third part 28 in the direction 27. For the guidance of the third part 28 on the shaft 10 of the first part 8, the guide face 14 is provided on the shaft 10 and a guide face 29, which cooperates with the guide face 14, is provided on the third part 28.

The third part 28 further comprises a guide face 30, which is formed so as to cooperate with an associated guide face 31 of the second part 9 so as to guide the second part 9 pivotably on the third part 28. An example possibility for arranging the guide faces 14, 29, 30, 31 is shown in FIG. 4A.

The holder 1c in accordance with the fourth embodiment of FIG. 4 further comprises a force application device 33, which is formed with a helical spring 23 and a torsion spring 32. The helical spring 23 is in the form of a compressive spring and is arranged in such a way that it is present against a recess 24 on the shaft 10 of the first part 8 and can exert a force on the third part 28 so as to slide the third part 28 in the arrow direction 34. By contrast, the torsion spring 32 is coupled to the third part 28 and the second part 9 in such a way and is arranged in such a way that it can press the second part 9 against the component 2 in the arrow direction 35. As for the holder 1a, the force application device makes it easier for the worker to attach the self-fixing holder 1c. The holder 1c additionally makes two-axis compensation of manufacturing tolerances of the component 2 possible.

In the holder 1c, adhesive layers 17 and 18 are formed as disclosed above for the first and third embodiment. By injecting an adhesive free of hard glass microspheres between the guide faces 30 and 31 and between the guide faces 14 and 29, these guide faces are glued, so as to prevent peeling stress of the adhesive layers 17, 18. After the adhesives have hardened, there is again a positively glued holder having an extremely high loading capacity.

In the holder 1c in accordance with the fourth embodiment, a further part 36 is additionally provided on the first part 8, and is arranged on the first part 8 pivotably with respect thereto. For this purpose, the first part 8 may for example comprise a round journal 37. The further part 36 is guided pivotably on the first part 8 by means of additional guide faces 38, 39, in other words for example an outer face of the journal 37 and an inner face assigned thereto of a round clearance in the further part 36. An interface device 16 is provided on the further part 36, it also being possible to provide (as in FIG. 4) or not to provide a further interface device 16 on the shaft 10 of the first part 8. By pivoting the further part 36 in the arrow direction 40, the interface device 16 can be brought into the desired position on the part 36 with respect to the component 2. Preferably, the guide faces 38, 39 are also glued together so as to fix the orientation of the further part 36 with respect to the first part 8. Alternatively, however, the further part 36 can also be fixed to the first part 8 without gluing, by means of a plug-in or latch connection or the like. In addition, it is noted that if required an interface device 16 could also be provided on the second part 9 or on the third part 28.

FIGS. 5 and 6 show a holder 1d in accordance with a fifth embodiment of the invention. The holder 1d comprises a first part 41, as well as a second part 42 and a third part 43. The first part 41 is in the form of a resilient element, a spring steel sheet bent in a U-shape in the embodiment shown. A first holder portion 4 and a second holder portion 5 are in the form of portions of the first part 41. As a result of the arrangement of the holder portions 4 and 5 on the resilient element, a defined relative movability (cf. arrows 44) of the holder portions 4 and 5 with respect to one another with resilient deformation of the resilient element is achieved. This movability makes it possible to receive a portion 3 of the component 2 between the holder portions 4 and 5 and to glue it to the component 2 by means of the adhesive layers 18 and 17, applied to first and second adhesive faces 6 and 7 formed on opposing limbs 41a, 41b of the first part 41, preferably comprising an adhesive having hard glass microspheres contained therein. A contact force can be applied by means of the resilient element of the first part 41, in other words the spring steel sheet, in such a way that the use of tongs etc. can be omitted when the bias from the spring steel sheet is sufficient. In the embodiment of FIGS. 5 and 6, the spring steel sheet or the resilient element thus also acts as a force application device. In FIG. 6, the holder 1d in accordance with the fifth embodiment is shown in a state where it is glued to the component 2 by means of the adhesive layers 17 and 18.

From the view of FIG. 5, it can be seen that in the holder 1d in accordance with the fifth embodiment the two adhesive faces 6 and 7 are each subdivided by two partial adhesive faces, only the two partial adhesive faces 6a and 6b of the adhesive face 6 being visible in FIG. 5. For clarity, the partial adhesive faces 6a and 6b are each bordered by a dotted line. As can be seen from FIG. 5, the partial adhesive faces 6a and 6b are formed in that the spring steel sheet which forms the first part 41 comprises a slit 45 in the region of each of the limbs 41a, 41b thereof. The subdivision of the adhesive faces 6 and 7 into the two partial adhesive faces, which is carried out in the same way for both adhesive faces 6, 7, makes the holder 1d in accordance with the fifth embodiment more tolerant to damage, since the holder 1d is still held reliably on the component 2 even if one of the adhesions in the region of one of the adhesive faces 6a or 6b fails for example.

As is shown schematically in FIG. 6, the third part 43 may comprise a rod-like portion 46 and a thickened portion 47, which in the fifth embodiment is cylindrical by way of example. In the region of an apex 48 of the first part 41, the thickened portion 47 of the third part 43 is enclosed in portions by the first part 41 and guided thereon. For this purpose, a guide face 49 of the third part 43 cooperates with a guide face 50 of the first part 41.

The first part 41 of the holder 1d in accordance with the fifth embodiment is further provided in the region of the apex 48 with a through-opening 51, through which the rod-like portion 46 of the third part 43 extends. The through-opening 51 is dimensioned in such a way that the third part 43 can be pivoted about an axis 52 with respect to the first part 41, as indicated by the arrow 53.

In the fifth embodiment, the second part 42 is in the form of a sleeve-like piece, which is formed in the manner of a hollow cylinder and/or in a crescent shape and is positioned on the first part 41 in the region of the apex 48 in portions. A guide face 54 of the second part 42 cooperates with an outer guide face 55 of the first part 41. In the holder 1d, the guide faces 54, 55 and 49, 50 are substantially in the form of portions of cylinder faces.

The holder 1d in accordance with the fifth embodiment is likewise provided to connect a module (not shown in the drawings) to the component 2 of an aircraft or spacecraft. In the fifth embodiment, the module is coupled to the holder directly or indirectly by means of an interface device 16, which is arranged on the orientable rod-like portion 46 of the third part 43, and which, in the holder 1d too, is formed in a suitable manner, for example with an internal thread in FIG. 5, 6, similarly to in the preceding embodiments.

The rod-like portion 46 of the third part 43 penetrates through the second part 42, which is provided with a suitable opening 56 for this purpose. In the region of the penetration, an outer face of the rod-like portion 46 cooperates, as a guide face 57, with the inner face of the opening 56, which is in the form of a guide face 58. In the holder 1d, in the initial state, the parts 42 and 43 are also initially movable relative to one another; the guide faces 57, 58 provide a guide for this purpose.

So as to counter a peeling stress of the adhesive connection of the holder 1d to the component 2 in the fifth embodiment in the region of the first and second adhesive layers 17 and 18, and so as to inhibit the movability of the interface device 16 with respect to the first part 41 and thus also with respect to the component 2, when the holder 1d is fixed to the component 2 the guide face 49 is glued to the guide face 50, the guide face 54 to the guide face 55, and the guide face 57 to the guide face 58, in that a suitable adhesive, preferably free of hard particles, is injected between the guide faces. For this purpose, suitable arrangements (not shown in detail) for facilitating the injection of adhesive may again be provided in the region of some of the guide faces.

In a variant of the fifth embodiment, the thickened portion 46 may be spherical in form. In this case, the through-opening 51 and the opening 56 are expediently dimensioned in such a way that the rod-like portion 46 can be pivoted not only about the axis 52 along the arrow 53, but also transverse thereto, as indicated in FIG. 5 by the arrow 59 by way of example. In this variant, it may be the case that the cylindrical guide face 50 of the first part 41 can only be glued to a spherical outer face 49 of the portion 47 in small face regions. In such a case, a peeling stress in the region of the adhesive faces 6 and 7 may be countered at least by way of the gluing of the guide faces 54, 55 and 57, 58. Alternatively, however, in a variant the guide face 50 may be adapted in shape to the guide face 49 of the spherical, thickened portion 47.

In FIG. 6, glued faces are again shown by way of example, dashed or in a black and white pattern.

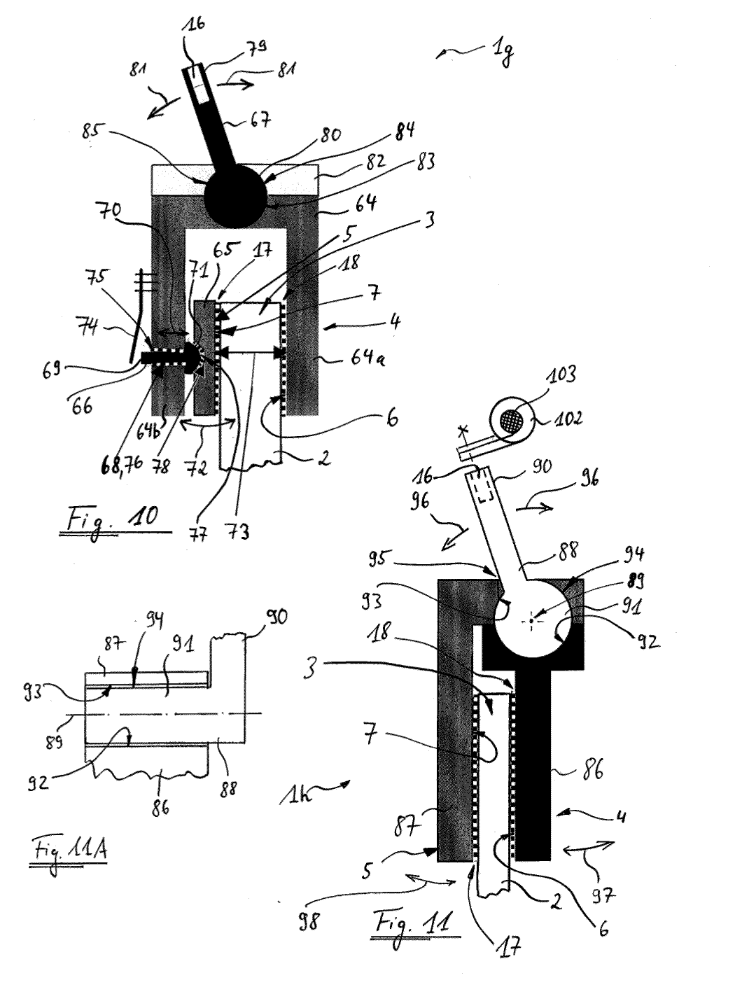

FIGS. 7 and 8 show a holder 1e in accordance with a sixth embodiment of the invention, FIG. 7 being a front view of the holder 1e and FIG. 8 being a section B-B, as indicated in FIG. 7, of the holder 1e. The holder in accordance with the sixth embodiment substantially comprises all of the features of the holder 1d in accordance with the fifth embodiment, and so reference may be made to the above statements in this regard. Unlike the fifth embodiment, however, the holder 1e of FIGS. 7 and 8 comprises four adhesive shoes 60a, 60b, 61a, 61b, which make is possible to adapt the holder 1e in accordance with the sixth embodiment to a predetermined thickness of the portion 3 of the component 2; see FIG. 8. The thickness is again denoted by reference numeral 20. Partial adhesive faces 6a, 6b, 7a, 7b are provided on surfaces, facing the component 2, of the adhesive shoes 601, 61a, 60b, 61b. In FIGS. 7 and 8, the adhesive shoes are substantially cuboid, in other words of substantially rectangular cross section; however, the adhesive shoes could also be of a different shape and taper for example upwards, downwards or to the side, so as to be able to glue the holder 1e to a correspondingly shaped portion 3 of the component 2. If required, the adhesive shoes could also comprise recesses and the like.

For the further elements provided with reference signs in FIGS. 7 and 8, reference is made to the statements relating to FIGS. 5 and 6.

The seventh embodiment of FIG. 9 constitutes a variant of the third embodiment. The holder if in accordance with the seventh embodiment comprises all of the features of the third embodiment, and so reference may be made to the above statements in this regard. In addition, the holder if in accordance with the seventh embodiment comprises a hemispherical projection 62, which forms an assembly aid, in the region of the second adhesive face 7. The portion 3 of the component 2, which is formed with a T-shaped cross section in the embodiment of FIG. 9, comprises a depression 63, which is likewise formed with a hemispherical internal surface. As is shown in FIG. 9, the depression 63 does not extend through the portion 3, but instead is merely worked some distance into the portion 3. The depression 63 could for example be produced by means of a small ball cutter or the like. Because of the spherical rounding and low depth thereof, a depression 63 of this type does not or does not significantly weaken the portion 3 of the component 2. However, in cooperation with the projection 62 corresponding to the depression 63, the positioning of the holder if on the component 2 is greatly simplified for the worker. When the holder if in accordance with the seventh embodiment is glued to the component 2, the projection 62 penetrates into the depression 63, where it is glued thereto.

Alternatively, the projection 62 could be arranged on the first holder portion 4 instead of on the second holder portion 5, meaning that the holder could for example be fixed to the component 2 the other way around, with an interface device 16 facing to the right in FIG. 9.

A holder 1g in accordance with an eighth embodiment is shown in FIG. 10. A first part 64, a second part 65, a third part 66 and a fourth part 67 are provided in the holder 1g. The first part 64 is formed substantially U-shaped, with two limbs 64a and 64b. The limb 64b comprises a through-opening 68, in which a pin-like portion 69 of the third part 66 is displaceably guided. The displaceability of the third part 66 relative to the first part 64 is indicated by the arrow 70.

The third part 66 is generally mushroom-shaped, a head 71 which is spherical in portions being formed on one end of the pin-like portion 69. In a variant, the head 71 could also be cylindrical in portions. The second part 65 is guided pivotably on the head 71 of the third part 66. The pivotability is indicated by the arrow 72. By means of the displaceability of the third part 66 relative to the first part 64, and by means of the pivotability of the second part 65 relative to the third part 66, on the one hand an opening width 73 between the second part 65 and the limb 64a of the first part 64 can be adapted to the dimensioning of a component 2, and in addition the inclination of the second part 65 with respect to the limb 64a can be adjusted so as to deal with components 2 of different shapes.

In addition, the holder 1g of FIG. 10 comprises a spring element 74, which is arranged on and is fixed to the first part 64. The spring element 74 may for example be in the form of a spring steel sheet. By means of the spring element 74, a force, which presses the third part 66 and thus also the second part 65 towards the component 2 and the limb 64a, is applied to the third part 66. For this purpose, the spring element 74 is positioned in portions on the third part 66. In FIG. 10, the spring element 74 is shown pulled away from the third part 66 counter to the spring force thereof.

As well as the possibility of a positive adhesion with a high loading capacity whilst preventing peeling stresses, the holder 1g of FIG. 10 also has the advantage of being formed to be self-fixing. Further, the holder 1g of FIG. 10 makes two-axis tolerance compensation possible, on the one hand in relation to the thickness of the portion 3 of the component 2, and on the other hand in relation to the parallelism of side faces thereof. This results in a relatively wide range of use for the holder 1g of FIG. 10.

So as to fix the holder 1g of FIG. 10 to the component 2, in this embodiment too a suitable adhesive, which contains hard, compression-resistant glass microspheres of a predetermined diameter, is applied to the first and second adhesive faces 6 and 7, the first adhesive face 6 being arranged on the limb 64a of the first part 64 and the second adhesive face 7 being arranged on the second part 65. The diameter of the glass microspheres is adapted to the width of the desired adhesive gap and thus to the desired thickness of adhesive layers 17 and 18. However, the adhesive may instead initially be applied to the portion 3 of the component 2. As a result of the force of the spring element 74, the limbs 64a and the second part 65 are pressed together and against the component 2, the second part 65 being adapted to the component 2 by means of the movements 70 and 72, resulting in particular in a uniform adhesive gap for the adhesive layers 17 and 18 being achieved.

In the holder 1g in accordance with the eighth embodiment, as shown in FIG. 10, the third part 66 is guided displaceably on the first part 64 relative thereto by means of cooperating guide faces 75 and 76. The guide face 75 is formed by an outer face of the pin-like end 69, whilst the guide face 76 is formed by an inner face of the through-opening 68.

An outer face of the head 71 forms a guide face 77, on which the second part 65 is guided by means of a guide face 78, which forms a spherical segment-shaped inner face of a clearance in the second part 65. So as to prevent a peeling stress when the holder 1g is loaded with a module to be connected (not shown in FIG. 10), when the holder 1g of FIG. 10 is fixed, after the formation of the adhesive layers 18 and 17 between the holder portions 4, 5 and the component 2, an adhesive free of hard glass microspheres is injected between the guide faces 75 and 76 and 77 and 78, and glues the guide face 75 to the guide face 76 and the guide face 77 to the guide face 78.

As can further be seen from FIG. 10, the holder 1g in accordance with the eighth embodiment likewise comprises an interface device 16 for directly or indirectly coupling the module to the holder 1g. The interface device 16 is arranged on a rod-like portion 79 of the fourth part 67. The fourth part 67 additionally comprises a cylindrical portion 80, which makes it possible to pivot the fourth part 67 in direction 81. This advantageously makes it possible to adjust the interface device 16 with respect to the component 2 for different applications.

The cylindrical portion 80 is thus guided on the first part 64 pivotably relative thereto. Specifically, the holder 1g of FIG. 10 additionally comprises a fifth part 82, which is fixed in a suitable manner to the first part 64. The fifth part 82 may be glued to the first part 64, or else alternatively or additionally may also be connected thereto by way of a plug-in or latch connection or the like. The first part 64 comprises a semi-cylindrical clearance, the inner face of which forms a guide face 83. The fifth part 82 likewise comprises a clearance, which comprises a surface which is likewise cylindrical in portions and which forms a guide face 84. An outer surface of the cylindrical portion 80 forms a further guide face 85. As a result of the cooperation of the guide faces 83, 84 and 85, the fourth part 67 is guided pivotably on the first part 64. The fifth part 82 may additionally comprise a sufficiently large through-opening, through which the rod-like portion 79 can extend.

In a variant, the portion 80 of the fourth part 67 could alternatively be spherical in form, instead of cylindrical, in which case the guide faces 83, 84 and 85 would respectively form portions of spherical faces.

It can be seen that in the holder 1g of FIG. 10 the interface device 16 can be adjusted in various ways with respect to the component 2. If the fourth part 67 is orientated in the desired position, an adhesive free of glass microspheres is injected between the guide face 85 on the one hand and the guide faces 83, 84 on the other hand, as for the guide faces 75-78, so as to glue them together, fixing the fourth part in place.

In a further variant of the eighth embodiment, the fourth part 67 and the fifth part 82 can be omitted, one or more interface devices 16 preferably being arranged directly on the first part 64 in a variant of this type.

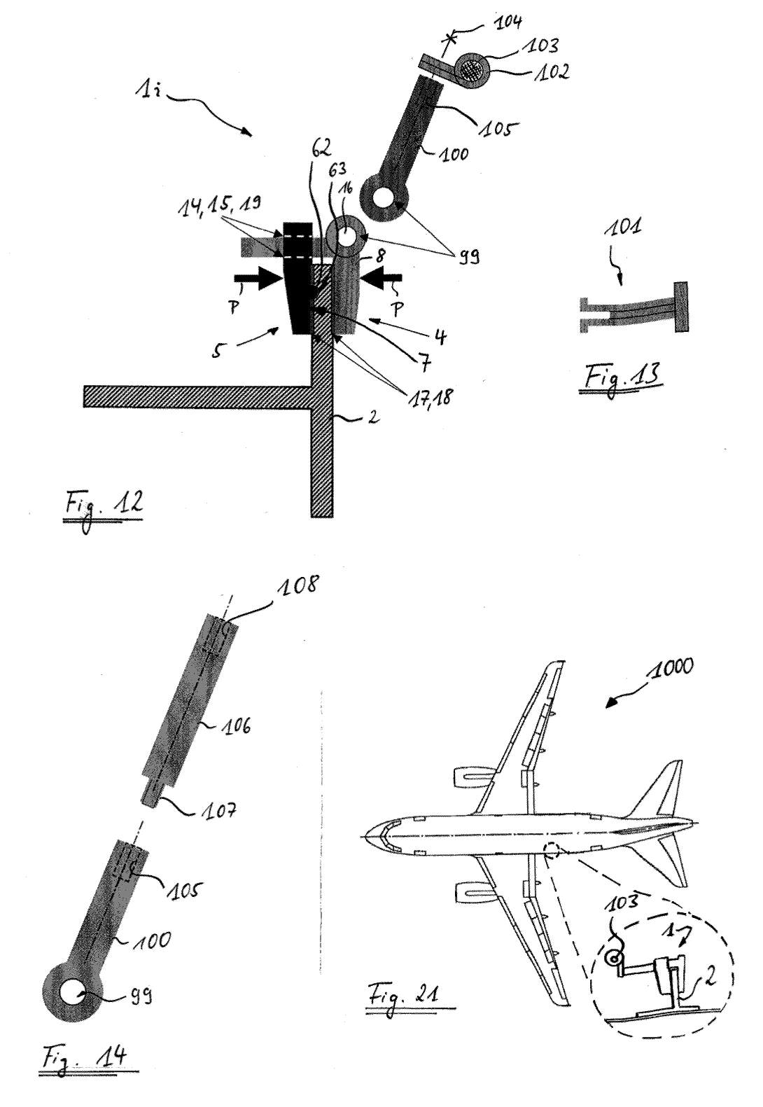

A holder 1h in accordance with the ninth embodiment is shown in FIG. 11.

The holder 1h in FIG. 11 comprises a first part 86, a second part 87 and a third part 88. First and second holder portions, which are movable relative to one another in a defined manner, are again denoted by reference numerals 4 and 5 in FIG. 11. The first holder portion 4 forms a portion of the first part 86; the second holder portion 5 forms a portion of the second part 87. In the holder 1h of FIG. 11, a simple and compact construction is achieved. The defined movability of the holder portions 4 and 5 is implemented by pivoting them about a shared pivot axis 89.

In detail, the third part 88 comprises a rod-like portion 90 and a cylindrical portion 91. The first part 86 is provided with a clearance, of which the inner surface forms part of a cylinder surface and is in the form of a guide face 92. The second part 87 likewise comprises a clearance, which is formed in portions with a cylinder surface which forms a guide face 93. An outer surface, which is cylindrical in portions, of the cylindrical portion 91 forms a guide face 94. In addition, the second part 87 may comprise a through-opening 95, which is merely indicated schematically in FIG. 11 and through which the rod-like portion 90 can extend.

Alternatively, the rod-like portion 90 may be arranged on one end of the cylindrical portion 91, making it optionally possible to omit a through-opening. An example variant of this type is sketched in FIG. 11A.

As a result of the cooperation of the corresponding guide faces 92, 93 on the one hand and 94 on the other hand, the first and second parts 86 and 87 can each be pivoted on the third part 88 relative thereto. The shared pivot axis of the first and second parts 86, 87 is denoted by reference numeral 89. In addition, the third part 88 can also be pivoted about the axis 89 relative to the first and second parts 86, 87 if they are already fixed in position relative to one another. In this way, advantageously, on the one hand an interface device 16 is made orientable on the rod-like portion 90 of the third part 88, and on the other hand a defined relative movability of the first and second holder portions 4 and 5 with respect to one another is made possible in a compact manner. The pivotability of the third part 88 is denoted by reference numeral 96, the pivotability of the first part 86 by reference numeral 97, and the pivotability of the second part 87 by reference numeral 98.

So as to mount the holder 1h of FIG. 11 on a component 2 of an aircraft or spacecraft, an adhesive provided with hard glass microspheres is applied to first and second adhesive faces 6 and 7. The first adhesive face 6 is arranged on the first part 86 and the second adhesive face 7 on the second part 87. Alternatively, the adhesive comprising the glass microspheres may also be applied to the component 2 in the region of the portion 3 thereof. Subsequently, the first and second holder portions 4, 5 are pressed against the component 2, thereby achieving adhesive layers 18 and 17 of defined thickness. In the example of FIG. 11, a suitable device, for example tongs, is preferably used for pressing the holder portions 4 and 5 against the component 2, the device being removed again after the adhesive used has hardened. A peeling stress of the adhesive connection in the region of the adhesive faces 6 and 7 is prevented in the embodiment of FIG. 11 in that an adhesive free of glass microspheres is injected between the guide face 94 on the one hand and the guide faces 92, 93 on the other hand, so as to glue the guide faces 92-94 together.

In a variant of the ninth embodiment, a third part 88 can be omitted. In this variant, the first part 86 is thus guided pivotably on the second part 87, it being possible for this purpose for one of the parts 86, 87 to comprise a cylindrical journal and the other of the parts 86, 87 to comprise a corresponding cylindrical clearance, having cooperating and gluable guide faces.

In a further variant, a torsion spring may for example be provided so as to bias the parts 86, 87 against the portion 3 of the component 2 by spring force.

The holder 1h may be useful both on components 2 having parallel side faces and on components 2 having side faces inclined with respect to one another.

A tenth embodiment of the invention is shown in FIG. 12-14. The holder 1i of FIG. 12 constitutes a variant of the first embodiment. As can be seen from FIG. 12, the holder 1i does not comprise a force application device, and so a contact force for gluing the holder 1i to a component 2, which is shown formed substantially with a T cross section, has to be applied using a separate device, such as tongs. The contact pressure is denoted by reference sign P. As described previously in relation to FIG. 9, an assembly aid in the form of a hemispherical projection 62 is provided on an adhesive face 7, the projection 62 engaging in a correspondingly configured hemispherical clearance or depression 63 on the component 2. In this way, automatic positioning of the holder 1i is advantageously achieved without a significant notching effect and without significant structural weakening of the component 2. In addition, by means of the projection 62 and the depression 63, an additional positive fit of the holder 1i to the component can be achieved. The adhesive layers 17 and 18, achieved as in the above-disclosed embodiments using an adhesive having hard glass microspheres of a defined diameter mixed in, are denoted again in FIG. 12. In addition, the guide faces 14 and 15, glued as in the first embodiment of FIG. 1, are schematically indicated.

An interface device 16 for indirectly coupling a module 103 to the holder 1i is provided on the first part 8 of the holder 1i of FIG. 12. The functionality thereof is to be explained in greater detail in the following.

As can be seen from FIG. 12, in the embodiment of FIG. 12 the interface device 16 is formed as an opening or clearance which forms part of a plug-in connection. The plug-in connection is denoted as a whole by reference numeral 99. It may for example be configured in such a way that a suitable opening, for example provided with a toothing (not shown in detail in FIG. 12), is provided respectively on the first part of the holder 8 and on an extension part 100. After the part 100 is suitably positioned with respect to the first part 8 in the desired orientation, the openings of the plug-in connection 99 being superposed, a plug-in element 101 (see FIG. 13) can be introduced into them, and latches in, for example by way of a latch connection on one of the parts 8 or 100, and thus remains in position and permanently connects the first part 8 to the extension part 100. If desired, the plug-in connection 99 may additionally be glued for security.

A further interface device, which in this case is in the form of a thread 105 by way of example, is provided on an upper end of the extension part 100. By means of a screw 104 and the thread 105, a P clip 102 can be fixed to the extension part 100. The P clip 102 is ultimately used for direct coupling to the module 103, which in FIG. 12 is in the form of a line, such as an electrical cable, and is enclosed by the P clip 102.

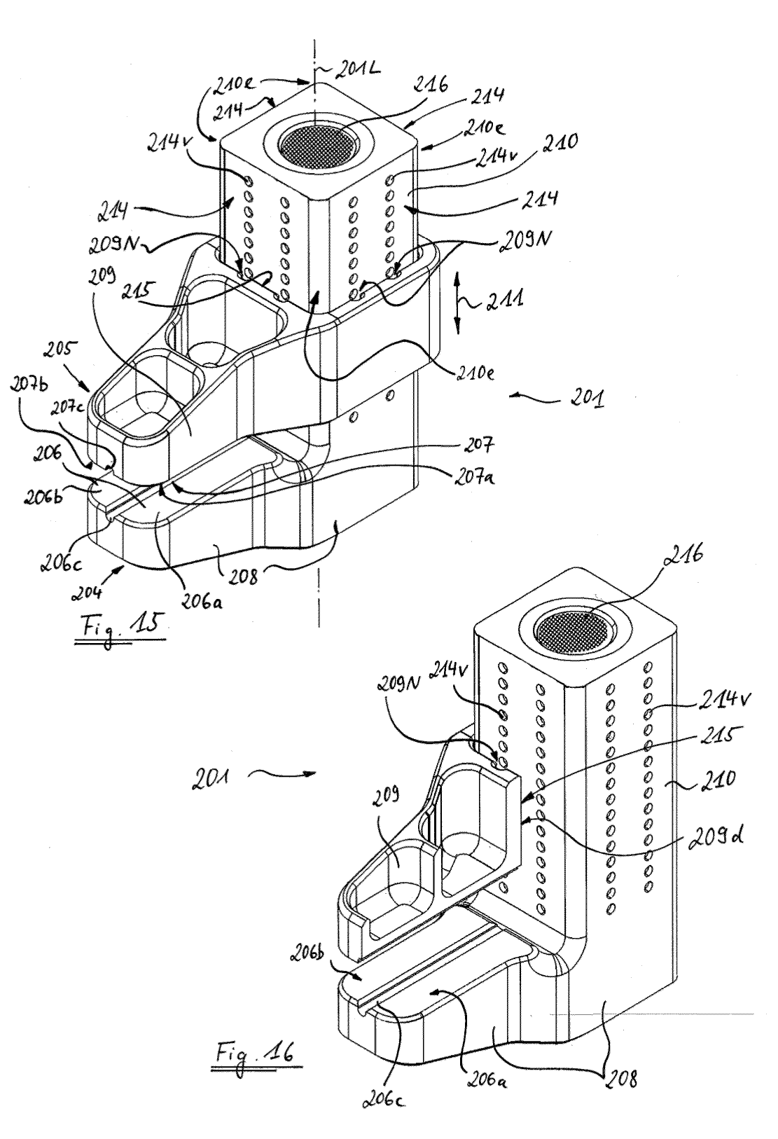

FIG. 14 shows how, if required, the distance of the module 103 from the component 2 can be further increased by means of a further extension part 106 having an end 107 provided with a thread and having a further internal thread 108. It can thus be seen that a kit-like holding system can be provided, which can deal with a large number of very different mounting tasks, in particular in aircraft or spacecraft such as aeroplanes.

FIGS. 15 to 19 show a holder 201 in accordance with a further preferred embodiment of the present invention.

The holder 201 of FIGS. 15 to 19 constitutes a development of the holder design previously disclosed in relation to FIG. 1. The holder 201 comprises a first part 208 and a second part 209 which are guided displaceably on one another. As can clearly be seen from FIG. 15, the holder is formed in the manner of a collet, a first holder portion 204 which forms a portion of the first part 208 and a second holder portion 205 which forms a portion of the second part 209 constituting the first and second jaws of the collet. The holder 201 in accordance with the eleventh embodiment again serves to connect a module (not shown in FIG. 15-19) to a component 2 (see FIG. 19) of an aircraft or spacecraft (not shown in its entirety).

Two partial adhesive faces 206a and 206b are arranged on the first holder portion 204, and form parts of a first whole adhesive face 206. The partial adhesive faces 206a and 206b are positioned substantially mutually parallel in a plane and are separated from one another by a groove 206c.

A second whole adhesive face 207 is provided on the second holder portion 205, and is arranged substantially opposite and parallel to the first whole adhesive face 206. The second whole adhesive face 207 is also divided into two second partial adhesive faces 207a and 207b, which are again, like the first whole adhesive face 206, separated from one another by a groove 207c.

FIG. 15 shows an initial state of the holder 201, in which it is not yet fixed to a component 2. In this state, the second part 209 can be displaced along a shaft 210 formed on the first part 208, in a straight line in the direction 211 on the shaft 210, relative to the first part 208. In this way, the two parts 208 and 209 can be moved with respect to one another in a defined manner in the initial state. The movability of the holder portions 204, 205 with respect to one another in the direction 211 makes it possible to receive the portion 3 of the component 2 of the aircraft or spacecraft (cf. FIG. 19) between the two holder portions 204 and 205.

As can further be seen from FIG. 15, the shaft 210 is formed with a cross section which is substantially rectangular, for example square with rounded corners 210e, as seen perpendicular to a longitudinal axis 201L of the holder 201 and thus perpendicular to the displacement direction 211. The peripheral face of the shaft 210 forms a peripheral guide face 214 for guiding the second part 209.

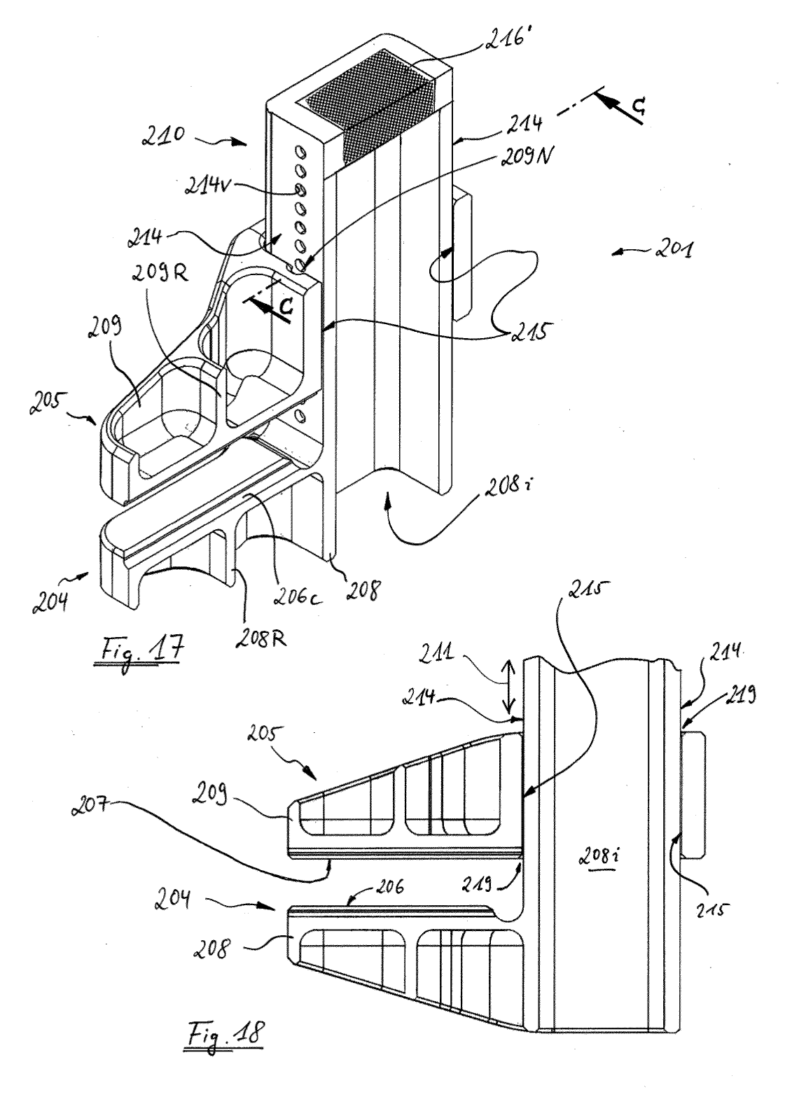

From FIGS. 15 to 19, it can additionally be seen that the second part 209 of the holder 201 encloses the shaft 210 in the peripheral direction thereof, and the shaft 210 thus penetrates through the second part 209. The second part 209 thus comprises a through-opening 209d (see FIG. 16). The inner face of the through-opening 209d forms a peripheral guide face 215.

As a result of the cooperation of the guide faces 214 and the guide face 215, the second part 209 is guided displaceably on the shaft 210 of the first part 208 in the initial state. The guide face 214 and the guide face 215 are thus assigned to one another for this purpose.

As is further shown in FIGS. 15 to 19, a number of injection grooves are provided on the second part 209 in the region of the guide face 215, which are denoted by reference sign 209N and the purpose of which is explained in greater detail in the following.

An interface device 216 is arranged on an end of the shaft 210 remote from the first holder portion 204 and thus from the first whole adhesive face 206, and is used for directly or indirectly coupling the holder 201 to a module (not shown). In the embodiment shown of FIGS. 15 and 16 for example the interface device 216 is provided on an end face of the shaft 210 and may for example be in the form of a threaded hole. However, the interface device 216 may instead be configured in any other expedient and suitable manner. A threaded hole is merely to be understood as an example. In the variant of FIG. 17, the interface device 216′ is shown highly schematically in a rather different manner; this could be a screw, latch or plug-in connection or another suitable manner of coupling the module to the holder 201. For completeness, it should be mentioned that, as the interface device, the holder 201 may also comprise a suitable device by means of which the module (not shown) can be coupled directly to the shaft 210. For example, the shaft 210 could be provided with a suitable clearance for a cable or the like, as is shown schematically in FIG. 1A for the shaft 10 of the holder 1. A plurality of interface devices 216, 216′ are also conceivable for the holder 201.

It can additionally be seen from FIGS. 15 to 17 and 19 that depressions 214v, distributed regularly in rows, are provided within the guide face 214. The rows extend in the direction of the longitudinal axis 201L. The purpose of the depressions 214v is likewise explained further in the following. In the drawings, only some of the depressions 214v are provided representatively with a reference sign. The depressions 214v may for example be provided with a rounded base, as can be seen in particular from FIG. 19.

The holder 201 is fixed to the component 2 of the aircraft or spacecraft, which may for example be a structural component such as a former of an aeroplane fuselage cell structure, in the manner disclosed in the following.

The holder 201 is provided in its initial state. In this state, the parts 208 and 209 are displaceable with respect to one another in the direction 211. By displacing the parts 208 and 209, the adhesive faces 206, 207 are moved sufficiently far away from each other so as to be able to apply an adhesive containing hard glass microspheres of predetermined diameter to the partial adhesive faces 206a, 206b, 207a, 207b. Alternatively, the adhesive may also be applied to opposing side faces 2a, 2b of the component 2.

Subsequently, the first holder portion 204 and the second holder portion 205 are moved towards one another by displacing the part 209 along the shaft 210, resulting in the component 2 being enclosed in the region of the portion 3 by the opposing faces 12, 13 (cf. FIG. 19), the portion 3 being received between the holder portions 204 and 205, and an adhesive layer 218 or 217 between the portion of the component 2 and the respective adhesive face 206, 207 being adjusted by pressing the holder portions 204, 205 against the component 2. The glass microspheres of defined diameter mixed into the adhesive ensure that the adhesive layers 218 and 217 have a precisely defined thickness, meaning that an optimum result can be achieved as regards the loading capacity and reliability of the adhesion.

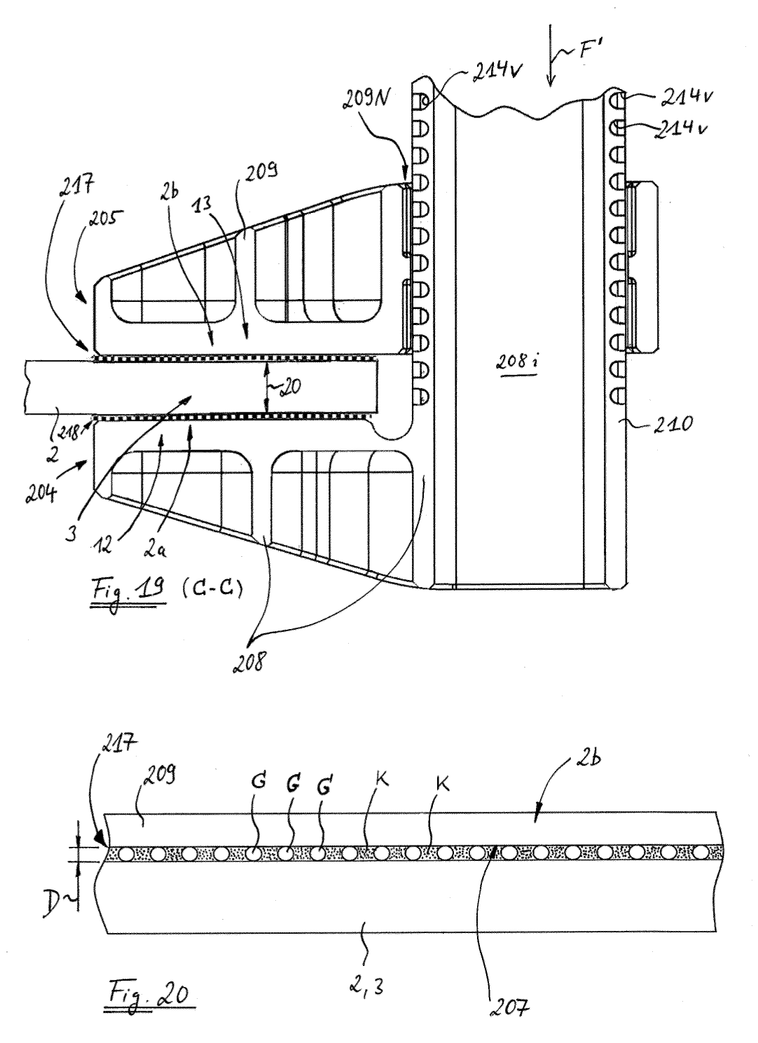

FIG. 20 shows schematically how the hard glass microspheres G, which are compression-resistant, bring about a defined thickness D for example of the adhesive layer 217. The proportion of the adhesive forming the adhesive layer 217 which is liquid or viscous in the unhardened state is denoted by reference sign K in FIG. 20.

During the hardening of the adhesive to form the adhesive layers 217 and 218, the first and second holder portions 204 and 205 are pressed against the component 2 by means of a device (not shown in the drawings), for example tongs or a similar means. The holder portions 204, 205 are thus glued to the component 2 by means of the adhesive layers 218, 217.

The guide faces 214, 215 are provided and formed suitably for being glued together by means of an adhesive which is free of the microspheres G. For this purpose, for example after the holder portions 204 and 205 are gripped against the component 2, an adhesive which is free of glass microspheres G is injected between the guide faces 214, 215, and thus into an adhesive gap 219 between them, by means of the injection grooves 209N. The adhesive thus fills the space between the guide faces 214, 215, as well as the injection grooves 209N and the depressions 214v. As a result, the guide faces 214, 215 are glued together, resulting in the part 208 and the second part 209 being fixed to one another.

The adhesive faces 206, 207, the parts 208, 209, and the guide faces 214, 215 are arranged in such a way that the gluing of the guide faces 214, 215, when the adhesive has achieved its target strength, prevents a peeling stress of the adhesive connection of the holder 201 to the component 2 in the region of one of the adhesive layers 217, 218, which might otherwise occur when the holder 201 is loaded with a load, introduced by way of the interface device 216, from the module. For example, gluing the guide faces 214, 215 prevents a force F′ (cf. FIG. 19) from leading to peeling in the region of the adhesive layer 218.

After the adhesive in the adhesive connections of the holder 201 has achieved its target strength, a mounting for the module having a high loading capacity is thus achieved, in which peeling stresses are prevented, and which can introduce considerable loads into the component 2 via the glass microspheres G. As a result of the positive enclosure and gluing to the component 2, the holder 201 has a high loading capacity, which gives it a wide range of applications. Not only system equipment parts such as cables, lines and the like can be held by means of the holder 201. It is also conceivable to connect relatively heavy modules to the primary structure of the aircraft or spacecraft by means of the holder 201. It is even conceivable to connect structurally supporting modules to a structural component 2. The continuous adjustability of the parts 208, 209 additionally provides the possibility of fixing the holder 201 to components 2 of different thickness in a practical manner.

The parts 208 and 209 of the holder 201 are preferably made of a plastics material. So as to increase the stability and rigidity of the holder 201, ribs 208R, 209R may be provided.

To save weight, the shaft 210 of the first part 208 is preferably formed hollow internally, and thus comprises a cavity 208i. In this way, a holder 201 can be achieved which is lightweight and is further formed rigidly, in particular including by means of the ribs 208R, 209R, and can receive large loads by way of the above-disclosed adhesion. In particular, the holder 201 may even for example be formed in such a way that it can be loaded as a primary structural component.

In addition, in the holder 201 the parts 208 and 209 cannot tilt with respect to one another as a result of the guidance by means of the shaft 210 provided for this purpose. A comparably large adhesive face can be achieved in the region of the guide faces 214, 215, and this further increases the effectiveness of the adhesion. Further, the holder 201 is easy to handle and can be fixed to the component 2 in a simple manner.

The grooves 206c, 207c increase the damage tolerance of the adhesion in the region of the adhesive faces 206, 207 in that the propagation of any cracks in the adhesive connection from one partial adhesive face into the adjacent partial adhesive face is inhibited. In the region of the guide faces 214, 215, the depressions 214v in the guide face 214 act as crack stoppers, so as also to prevent the propagation of cracks in this adhesive connection between the parts 208 and 209.

In all of the embodiments described above, the parts of the respective holder may advantageously be formed using a plastics material. The holder can thus be manufactured cost-effectively and has a low weight. In this embodiment, resilient elements, such as in particular spring elements, may preferably be formed using a suitable metal material.

In addition, in all of the above-disclosed embodiments, it may be advantageous to subdivide the adhesive faces on the first and second holder portion in each case into a plurality of partial adhesive faces, for example two, so as to provide redundancy and damage tolerance. This may for example take place as in the embodiment of FIG. 15-19. In addition, injection grooves and crack stopper depressions may also be used on guide faces in the other embodiments, as in the example of FIG. 15-19 or the like.

FIG. 21 is a plan view and an enlarged detail of an aircraft or spacecraft 1000 in the form of an aeroplane. A module 103, for example a cable, is fixed to a structural component 2, in FIG. 21 a stiffening element of a fuselage cell structure of the aeroplane 1000 by way of example, by means of the holder 1 of FIG. 1. Instead of the holder 1, any one of the holders 1a-1i or 201 in accordance with the above-disclosed embodiments can be used in the aeroplane 1000 of FIG. 21.

Those of the above-disclosed embodiments in which the interface device can be adjusted or orientated for adaptation to the mounting requirements, for example by pivoting, have the additional advantage that one holder type can be used in a wide range of applications.

Although the invention has been described herein with reference to preferred embodiments, it is not limited thereto, but can be varied in numerous ways.

In particular, the invention is not limited to holders made of a plastics material. For corresponding requirements on the bearing capacity, parts of the holder may instead be formed using a metal material.

Further, the holder is not limited to one interface device per holder; it is also possible to provide a plurality of interface devices on each of the holders on one or more of the parts thereof.

In addition, it should be noted that in the invention, instead of the adhesive with added glass beads for gluing the holder to the component 2, an adhesive free of hard particles of this type may alternatively be used, in which case a spacer arranged in a suitable place may preferably be used to adjust a defined adhesive gap.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A holder for connecting a module to a component of an aircraft or spacecraft comprising:
a first holder portion and a second holder portion, the first holder portion comprising at least one first adhesive face and the second holder portion comprising at least one second adhesive face,
wherein the first holder portion and the second holder portion are formed in such a way and are movable relative to one another in a defined manner in an initial state of the holder in such a way that a portion of the component can be received between the holder portions so as to glue the holder portions to the component by an adhesive layer in each case between the at least one adhesive face of the holder portion and the component;
wherein the holder comprises two or more parts,
wherein the parts or predetermined mutually cooperating parts from the more than two parts being guided so as to be movable relative to one another by mutually cooperating guide faces in the initial state of the holder,
wherein the guide faces are provided and are suitably formed for being glued together using an adhesive, and
wherein the adhesive faces, the parts and the guide faces are arranged in such a way that the gluing of the guide faces can be used to counter a peeling stress of an adhesive connection of the holder to the component of the aircraft or spacecraft in the region of at least one of the first and second adhesive faces when the holder is loaded by the connected module.

2. The holder according to claim 1, wherein the first holder portion and the second holder portion are set up to enclose the portion of the component from substantially opposite sides.

3. The holder according to claim 1, wherein a first of the parts and a second of the parts are guided movably relative to one another by the guide faces which are provided for this purpose, and in that the at least one first adhesive face is arranged on the first of the parts, and the at least one second adhesive face is arranged on the second of the parts, resulting in the first holder portion forming a portion of the first of the parts, and the second holder portion forming a portion of the second of the parts.

4. The holder according to claim 3, wherein the first of the parts and the second of the parts are guided displaceably relative to one another.

5. The holder according to claim 3, wherein the first of the parts and the second of the parts are guided pivotably relative to one another.

6. The holder according to claim 3, wherein the first of the parts and the second of the parts are guided displaceably and/or pivotably on one another by way of the cooperating guide faces which are provided for this purpose, of which one is provided on the first of the parts and one on the second of the parts.

7. The holder according to claim 3, wherein the holder comprises at least one interface device for directly or indirectly coupling the holder to the component, the interface device being provided on the first of the parts or the second of the parts.

8. The holder according to claim 3, wherein the first of the parts and the second of the parts are guided movably relative to one another by interposing a third of the parts, which is guided movably relative to the first of the parts and relative to the second of the parts by means the guide faces which are respectively provided for this purpose.

9. The holder according to claim 8, wherein the holder comprises at least one interface device for directly or indirectly coupling the holder to the component, the interface device being provided on the first of the parts or the second of the parts or the third of the parts.

10. The holder according to claim 3, wherein the holder comprises a further part which is guided movably on the first of the parts or on the second of the parts by additional guide faces, the holder comprising an interface device for directly or indirectly coupling the holder to the module and the interface device being provided on a further part.

11. The holder according to claim 1, wherein the first and second holder portions are in the form of portions of a first of the parts, the first of the parts comprising a resilient element or being in the form of a resilient element, the holder being formed in such a way that the movability of the holder portions relative to one another in a defined manner can be brought about in the initial state of the holder by resilient deformation of the resilient element.

12. The holder according to claim 1, wherein the holder comprises a force application device, which is set up to press the first and second holder portions against the portion of the component of the aircraft or spacecraft.

13. An arrangement in an aircraft or spacecraft which comprises a component of the aircraft or spacecraft, a module and a holder for connecting the module to the component of the aircraft or spacecraft, the holder comprising:
a first holder portion and a second holder portion, the first holder portion comprising at least one first adhesive face and the second holder portion comprising at least one second adhesive face,
wherein the first holder portion and the second holder portion are formed in such a way and are movable relative to one another in a defined manner in an initial state of the holder in such a way that a portion of the component can be received between the holder portions so as to glue the holder portions to the component by an adhesive layer in each case between the at least one adhesive face of the holder portion and the component;
wherein the holder comprises two or more parts,
wherein the parts or predetermined mutually cooperating parts from the more than two parts being guided so as to be movable relative to one another by mutually cooperating guide faces in the initial state of the holder,
wherein the guide faces are provided and are suitably formed for being glued together using an adhesive, and
wherein the adhesive faces, the parts and the guide faces are arranged in such a way that the gluing of the guide faces can be used to counter a peeling stress of an adhesive connection of the holder to the component of the aircraft or spacecraft in the region of at least one of the first and second adhesive faces when the holder is loaded by the connected module,
the holder portions of the holder each being glued to the component by an adhesive layer between the at least one adhesive face of the holder portion and the component, the guide faces being glued together and the module being held on the component by means of the holder.

14. The arrangement according to claim 13, wherein the adhesive layers by which the first holder portion and the second holder portion are glued to the component are formed using an adhesive which contains hard particles of a predetermined dimensioning, compressive forces being transmissible from the holder portions to the component via the hard particles.

15. A method for fixing a holder for connecting a module to a component of an aircraft or spacecraft, comprising:
providing a holder, which comprises a first holder portion and a second holder portion for receiving a portion of the component between the holder portions, the first holder portion comprising at least one first adhesive face and the second holder portion comprising at least one second adhesive face;
applying an adhesive to the adhesive faces and/or to the portion of the component of the aircraft or spacecraft;
bringing about or unblocking a movement of the first holder portion and the second holder portion relative to one another, in such a way that in each case an adhesive layer is formed between the at least one adhesive face of the holder portion and the portion of the component received between the holder portions, so as to glue each of the holder portions to the component;
introducing an adhesive into an adhesive gap between mutually cooperating guide faces, by which two or more parts of the holder or predetermined mutually assigned parts from the more than two parts of the holder are guided so as to be movable relative to one another in an initial state of the holder, so as to glue the guide faces together and so as to counter a peeling stress of an adhesive connection of the holder to the component of the aircraft or spacecraft, in the region of one or both adhesive faces, when the holder is loaded by the connected module, by gluing the guide faces.
